(19) United States
(12) Patent Application Publication
(10) Pub. No.: US 2013/0252201 A1
(43) Pub. Date: Sep. 26, 2013

(54) TONGUE GUARD AND METHOD OF USING SAME

(71) Applicant: Karen Rhoden, Brooklyn, NY (US)

(72) Inventor: Karen Rhoden, Brooklyn, NY (US)

(21) Appl. No.: 13/825,617

(22) PCT Filed: Sep. 22, 2011
(86) PCT No.: PCT/US11/52693

§ 371 Date: Jun. 4, 2013

Related U.S. Application Data
(60) Provisional application No. 61/385,255, filed on Sep. 22, 2010.

(51) Int. Cl. A61C 5/14

(52) U.S. Cl. CPC A61C 5/14
USPC 433/140; 433/215

(57) ABSTRACT

A tongue guard and a method for using the tongue guard, in particular for dental procedures, is described.

### FIELD OF THE INVENTION

The present invention relates to a tongue guard, and a method of using the tongue guard.

### BACKGROUND

Depending on the type of procedure, a dental practitioner may require the use of one or more tools at the same time, e.g., brushes, grinders, cutters, needles, mirrors, lights, suction equipment, and others. When many tools must be used simultaneously, a dental practitioner may find it difficult to effectively and efficiently perform a procedure alone. In such cases, other individuals may be required to assist the dental practitioner by manipulating one or more tools and devices. Thus, precise coordination of all tools, devices, and individuals may be needed for procedures requiring the use of multiple tools and devices simultaneously. At the same time, such complicated procedures must still be performed within the limited space of a mouth of a patient.

For example, some of the tools and devices may perform safety functions, such as protecting the tongue during a procedure to be carried out on the teeth. In such procedures, a dental practitioner may use a tool in one hand to manually protect the tongue while performing the procedure on teeth with a tool in the other hand. This may be a complicated and stressful situation in which the practitioner is required to concentrate on both the dental procedure to be completed and also the protection of the tongue. Alternatively, a dental assistant may manipulate such a tool to protect the tongue, and the dental practitioner may utilize the tool(s) to perform the dental procedure. This may relieve some of the burden on the practitioner such that he/she may focus solely on performing the dental procedure. However, as stated previously, the dental assistant must coordinate his/her movements with the practitioner and also be closely involved in the limited space for performing the procedure.

Accordingly, there is a need for a device to protect the tongue that does not require manual manipulation during a procedure by a practitioner or assistant. Advantages of such a tongue guard that protects the tongue from injury may include allowing a practitioner to concentrate more fully on the procedure to be performed, freeing a hand of the practitioner for other uses, reducing the need for multiple assistants, and reducing crowding and coordination problems among multiple tools and individuals.

The present invention, described herein, provides these advantages and others that will be readily apparent to those of ordinary skill in the art.

### SUMMARY

In a non-limiting embodiment of the present invention, a tongue guard comprises an anchor, and a shield attached to the anchor, in which the guard is configured to self-position between teeth and a tongue in a patient's mouth.

In an alternative non-limiting embodiment of the present invention, the guard is completely inserted into the patient's mouth.

In an alternative non-limiting embodiment of the present invention, the anchor includes an absorbent material.

In an alternative non-limiting embodiment of the present invention, the anchor includes at least one of cotton, gauze, foam, styrofoam, paper, cardboard, plastic, polymer, rubber, cork, and metal.

In an alternative non-limiting embodiment of the present invention, the anchor is at least one of cylindrical, tubular, rectangular, and oblong.

In an alternative non-limiting embodiment of the present invention, the anchor includes a mesh covering.

In an alternative non-limiting embodiment of the present invention, the shield is attached to the anchor by at least one of adhesive, interference fit, press fit, and fasteners.

In an alternative non-limiting embodiment of the present invention, the shield includes an absorbent material.

In an alternative non-limiting embodiment of the present invention, the shield includes a soft material supported by a hard backing material.

In an alternative non-limiting embodiment of the present invention, the shield includes at least one of cotton, gauze, foam, styrofoam, paper, cardboard, plastic, polymer, rubber, cork, and metal.

In an alternative non-limiting embodiment of the present invention, the shield includes a concave curvature facing the tongue, and a convex curvature facing the teeth.

In an alternative non-limiting embodiment of the present invention, the shield is configured to curve over an upper surface of the tongue.

in an alternative non-limiting embodiment of the present invention, the shield includes concave side edges.

In an alternative non-limiting embodiment of the present invention, the shield includes a convex upper edge.

In an alternative non-limiting embodiment of the present invention, the shield includes a mesh covering.

In an alternative non-limiting embodiment of the present invention, the shield includes a tapered shape.

In another non-limiting embodiment of the present invention, a method of using a tongue guard having an anchor and a shield attached to the anchor comprises inserting the guard between teeth and tongue in a patient's mouth, in which the guard is configured to self-position between the teeth and the tongue.

In an alternative non-limiting embodiment of the present invention, the guard is completely inserted into the patient's mouth.

In an alternative non-limiting embodiment of the present invention, the guard self-positions after insertion into the patient's mouth.

In an alternative non-limiting embodiment of the present invention, the method further comprises performing a dental procedure, and protecting the tongue by the inserted, self-positioned guard.

The present invention provides a tongue guard and a method for using the tongue guard. Although the present invention will be discussed herein with regard to dental procedures performed on teeth of a patient, it should be understood by those of ordinary skill in the art that the present invention may be applicable to other procedures in which a tongue guard may be used as well, and should not be limited to the examples described herein.

### BRIEF DESCRIPTION OF THE DRAWINGS

FIG. 1 is a schematic side view of a tongue guard according to an exemplary embodiment of the present invention.

FIG. 2 is a schematic front view of a tongue guard according to an exemplary embodiment of the present invention shown in a partial environment between teeth and a tongue.

FIG. 3 is a schematic side view of a tongue guard according to another exemplary embodiment of the present invention.

FIG. 4 is a schematic side view of a tongue guard according to yet another exemplary embodiment of the present invention.

### DETAILED DESCRIPTION

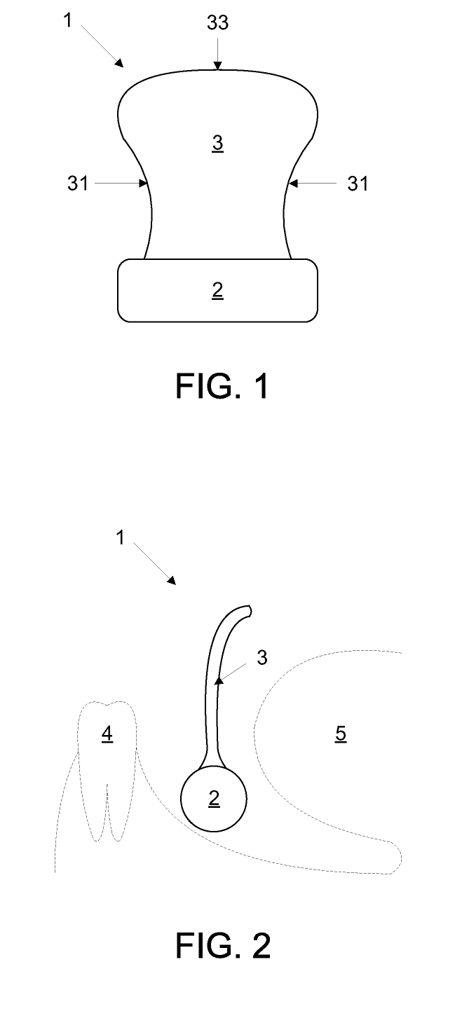

FIG. 1 shows a schematic side view of a tongue guard 1 according to an exemplary embodiment of the present invention. FIG. 2 shows a schematic front view of a tongue guard 1 according to an exemplary embodiment of the present invention shown in a partial environment between teeth 4 and a tongue 5.

The tongue guard 1 may include an anchor 2 and a shield 3 attached to the anchor 2, The anchor 2 and shield 3 may allow the guard 1 to self-position and/or self-anchor in a correct orientation within a patient's mouth. In addition, the guard 1 may be completely inserted into a patient's mouth. Further, the guard 1 may be sized such that it is large enough to prevent accidental swallowing by and/or choking of the patient while still being able to be completely inserted into a patient's mouth.

The anchor 2 may be made of an absorbent material. For example, the anchor 2 may be made of cotton, rolled cotton, compacted cotton, gauze, foam, styrofoam, paper, packed paper, backing paper, cardboard, plastic, polymer, rubber, cork, metal, and combinations thereof. The absorbent material of the anchor 2 may absorb moisture such that the anchor 2 self-molds to the shape of the mouth, further maintaining the self-positioning and/or self-anchoring of the guard 1. In addition, the anchor 2 may maintain a dry working field while in use.

The anchor 2 may have an elongated shape that may fit comfortably and securely within a patient's mouth. For example, the shape of the anchor 2 may be cylindrical, tubular, rectangular, oblong, and combinations thereof. In addition, the anchor 2 may include a curvature or angle to increase comfort for the patient during use. Further, the anchor 2 may be soft and malleable to conform to the shape of the patient's mouth.

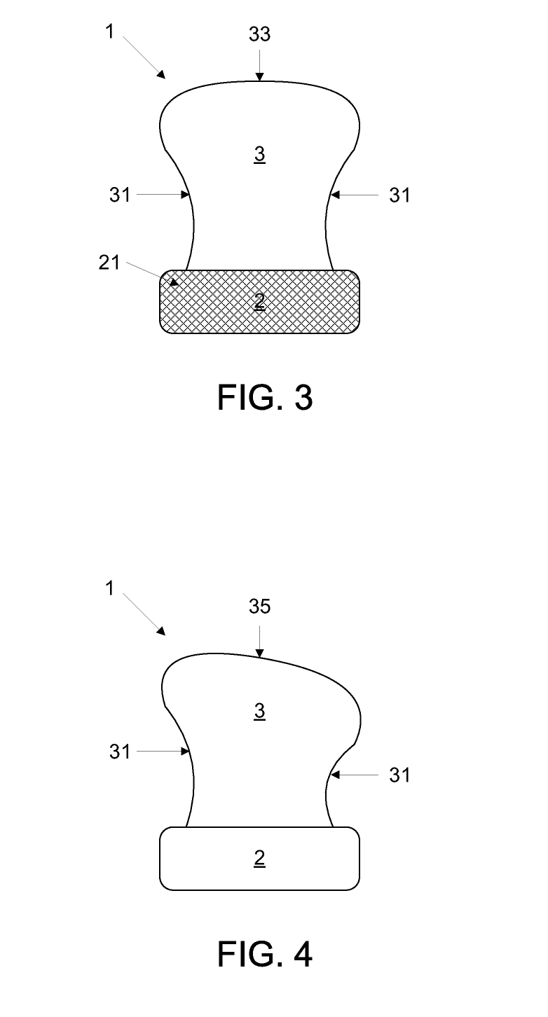

As shown in FIG. 3, the anchor 2 may also include a mesh covering 21 that may prevent disintegration and/or breaking apart of the anchor 2 in a patient's mouth, and that may limit the engorged size of an absorbent anchor 2. The mesh covering 21 may be made of cotton, gauze, foam, styrofoam, paper, cardboard, plastic, polymer, rubber, cork, fabric, metal, and combinations thereof. In alternative non-limiting embodiments, the mesh covering 21 may cover all or portions of the shield 3, as well as all or portions of the anchor 2.

The shield 3 may be attached to the anchor 2 by any suitable methods. For example, the shield 3 may be attached by adhesive, interference fit, press fit, listeners, other mechanical or chemical means, or combinations thereof. In addition, the shield 3 and anchor 2 may be integrally made or molded from the same material(s).

The shield 3 may be made of an absorbent material. For example, the shield 3 may be made of cotton, rolled cotton, compacted cotton, gauze, foam, styrofoam, paper, packed paper, backing paper, cardboard, plastic, polymer, rubber, cork, metal, and combinations thereof. Preferably, the shield 3 may include a soft, absorbent material supported by a relatively stiffer backing material to maintain the shape of the shield 3. The absorbent material of the shield 3 may absorb moisture such that the shield 3 self-molds to the shape of the mouth, further maintaining the self-positioning and/or self-anchoring of the guard 1.

From a front view as shown schematically in FIG. 2, the shield 3 may include a concave curvature facing the tongue 5, and a convex curvature facing the teeth 4. The shield 3 may also include other configurations that may be convex, concave, straight, curved, angled, or combinations thereof. Preferably, the shield 3 includes a curvature configured to extend over a portion of an upper surface of the tongue 5, thereby protecting the tongue 5 during dental procedures.

From a side view as shown schematically in FIG. 1, the shield 3 may preferably include concave side edges 31 and a convex upper edge 33. The shield 3 may also include other configurations that may be convex, concave, straight, curved, angled, or combinations thereof. For example, the shield 3 may include a tapered shape having a tapered upper edge 35, as shown in FIG. 4. The tapered upper edge 35 may be positioned within the patient's mouth such that the upper edge 35 tapers towards the back of the patient's mouth, or such that the upper edge 35 tapers towards the front of the patient's mouth, depending on the shape of the patient's mouth and the associated comfort level.

The precise shape of the shield 3 and its side edges 31 and upper edge 33 may be chosen to increase comfort for the patient during use. Further, the shield 3 may be soft and malleable to conform to the shape of the patient's mouth.

The shield 3 may also include a mesh covering, not shown, that may prevent disintegration and/or breaking apart of the shield 3 in a patient's mouth, and that may limit the engorged size of an absorbent shield 3. The mesh covering may be made of cotton, gauze, foam, styrofoam, paper, cardboard, plastic, polymer, rubber, cork, fabric, metal, and combinations thereof.

A method of using a tongue guard 1 according to an exemplary embodiment of the present invention may include inserting the guard 1 between the teeth 4 and a tongue 5 in a patient's mouth. The tongue guard 1 may be configured to self-position and/or self-anchor between the teeth 4 and the tongue 5. During the inserting step, the tongue guard 1 may be completely inserted into a patient's mouth. More specifically, the anchor 2 may be situated in a portion of the lower jaw between gums of the teeth 4 and a lower portion of the tongue 5. The shield 3 may extend upward from the anchor 2 between the teeth 4 and the tongue 5, and the shield 3 may curve or extend over a portion of an upper surface of the tongue 5, in order to protect the tongue 5 during dental procedures.

The method of using the tongue guard 1 may also include performing a dental procedure, and protecting the tongue 5 by the inserted, self-positioned guard 1, in which the guard 1 self-positions after placement in a patient's mouth.

A plurality of tongue guards 1 may be used during a dental procedure, in which the practitioner may exchange a used guard 1 for a new guard 1 when necessary. Additionally, a practitioner may use more than one guard 1 at the same time during a dental procedure, according to the requirements of the procedure. Advantageously, the tongue guard 1 allows for a hands-free operation, since the guard maintains its position and orientation, i.e., self-positioning and/or self-anchoring, after insertion such that a practitioner's hands are free to perform other tasks related to dental procedures.

What is claimed is:

1. A tongue guard, comprising:
an anchor; and
a shield attached to the anchor,
wherein the guard is configured to self-position between teeth and a tongue in a patient's mouth.

2. The guard according to claim 1, wherein the guard is completely inserted into the patient's mouth.

3. The guard according to claim 1, wherein the anchor includes an absorbent material.

4. The guard according to claim 1, wherein the anchor includes at least one of cotton, gauze, foam, styrofoam, paper, cardboard, plastic, polymer, rubber, cork, and metal.

5. The guard according to claim 1, wherein the anchor is at least one of cylindrical, tubular, rectangular, and oblong.

6. The guard according to claim 1, wherein the anchor includes a mesh covering.

7. The guard according to claim 1, wherein the shield is attached to the anchor by at least one of adhesive, interference fit, press fit, and fasteners.

8. The guard according to claim 1, wherein the shield includes an absorbent material.

9. The guard according to claim 1, wherein the shield includes a soft material supported by a hard backing material.

10. The guard according to claim 1, wherein the shield includes at least one of cotton, gauze, foam, styrofoam, paper, cardboard, plastic, polymer, rubber, cork, and metal.

11. The guard according to claim 1, wherein the shield includes a concave curvature facing the tongue, and a convex curvature facing the teeth.

12. The guard according to claim 1, wherein the shield is configured to curve over an upper surface of the tongue.

13. The guard according to claim 1, wherein the shield includes concave side edges.

14. The guard according to claim 1, wherein the shield includes a convex upper edge.

15. The guard according to claim 1, wherein the shield includes a mesh covering.

16. The guard according to claim 1, wherein the shield includes a tapered shape.

17. A method of using a tongue guard having an anchor, and a shield attached to the anchor, the method comprising:
inserting the guard between teeth and a tongue in a patient's mouth,
wherein the guard is configured to self-position between the teeth and the tongue.

18. The method according to claim 17, wherein the guard is completely inserted into the patient's mouth.

19. The method according to claim 17, wherein the guard self-positions after insertion into the patient's mouth.

20. The method according to claim 17, further comprising:
performing a dental procedure; and
protecting the tongue by the inserted, self-positioned guard.
